(19) United States
(12) Patent Application Publication
(10) Pub. No.: US 2010/0153719 A1
(43) Pub. Date: Jun. 17, 2010

(54) Lightweight Authentication Method and System for Low-Cost Devices Without Pseudorandom Number Generator

(75) Inventors: Dang Nguyen Duc, Yuseong-gu (KR); Hyunrok Lee, Yuseong-gu (KR); Kwangjo Kim, Yuseong-gu (KR)

Correspondence Address: CROWELL & MORING LLP;INTELLECTUAL PROPERTY GROUP, P.O. BOX 14300, WASHINGTON, DC, 20044-4300, US

(73) Assignee: INFORMATION AND COMMUNICATIONS UNIVERSITY, Yuseong-Gu (KR)

(21) Appl. No.: 12/337,495

(22) Filed: Dec. 17, 2008

(51) Int. Cl. H04L 9/32

(52) U.S. Cl. 713/168

(57) ABSTRACT

An algorithm or an authentication system for a low-cost authenticating device such as a radio frequency identification (RFID) tag, or a sensor node are provided, by which authentication is processed efficiently without requiring a random number. A claimant entity attempting to be authenticated and a verifying entity to authenticate the claimant entity, share a plurality of secret keys so that authentication is processed as the claimant entity responds to a challenge by the verifying entity. The verifying entity and the claimant entity perform authentication using Learning Parity with Noise (LPN) problem. The claimant entity may generate an encrypted value for use in the authentication, using a basic Boolean Exclusive OR and a logical AND operations.

### BACKGROUND OF THE INVENTION

1. Field of the Invention

Aspects of the present invention relate to an authentication method, protocol and system for verifying authenticity of an entity such as a radio frequency identification (RFID) tag, a sensor node, or the like.

2. Description of the Related Art

Entity authentication involves sending an identity or characteristic information by one entity using wired or wireless communication network, and executing a protocol to authenticate the received information by a responding entity. The authentication mainly uses symmetric key or public key.

Symmetric key-based authentication is a protocol by which entities participating in authentication exchange share a secret key on a one-to-one basis. This symmetric key authentication can guarantee high security, and entities involved in the authentication exchange can have symmetricity. However, the symmetric key authentication suffers from several shortcomings. That is, a large storage space is required to store secret keys, since symmetric key authentication requires that separate secret keys be generated and managed for each of the counterpart entities. Besides, a complicated hardware is required to manage the secret keys.

Public key-based authentication can be used between a verifying entity (‘verifier’) to authenticate a counterpart and a claimant entity (‘claimant’) attempting to be authenticated, in which the entities involved in the authentication exchange share a public key provided by a public organization. The public key-based authentication may be executed asymmetrically. For example, if a device such as a RFID reader is the verifier and RFID tags are the claimants, the verifier and the claimants A and B can share a public key, while the claimant A and the verifier share a secret key A to execute authentication. The claimant B and the verifier can share a secret key B to perform authentication.

While the verifier stores therein and manages all the keys required for authentication, including the secret keys A and B and the public key for the authentication with the claimants A and B, the claimant A stores the public key and secret key A, and the claimant B stores the public key and secret key B.

The symmetric key authentication and public key authentication protocols need complicated authentication processes at the claimants to ensure high security. To perform complicated authentication processes, the hardware of the claimants has increased complexity and thus becomes more expensive. This makes the above authentication protocols unsuitable for use on a low-cost device such as RFID tag.

Particularly, considering that the hardware to generate pseudorandom number is expensive, there is a need for an authentication protocol for use with a RFID tag, which is capable of executing efficient authentication without requiring a pseudorandom number generator.

### SUMMARY OF THE INVENTION

Aspects of the present invention provide an entity in an authentication system applicable on a low-cost device without requiring a pseudorandom generating process.

Aspects of the present invention also provide an authentication system and method which do not suffer from incompleteness problem.

Aspects of the present invention also provide an authentication system and method which are secure against active attack.

In accordance with an example embodiment of the present invention, there is provided an authentication system including a verifying entity to authenticate a counterpart and a claimant entity attempting to be authenticated, in which the verifying entity and the claimant entity share a first and second shared secret keys and authentication is processed as the claimant entity responds to a challenge by the verifying entity. The verifying entity chooses a challenge key and a secret value, chooses a first calculated value based on the first shared secret key, the challenge key and the secret value, and sends the challenge key and the first calculated value to the claimant entity.

The claimant entity receives the challenge key and the first calculated value from the verifying entity, and predicts a secret value that corresponds to the first calculated value based on the challenge key, the first calculated value and the first shared secret key.

The claimant entity generates a first response value based on the second shared secret key and the challenge key and sends the first response value to the verifying entity, if the predicted secret value is a first value. If the predicted secret value is a second value, the claimant entity converts the challenge key using a permutation function shared with the verifying entity, generates a second response value based on the converted key and the second shared secret key, and sends the second response value to the verifying entity.

In accordance with another example embodiment of the present invention, there is provided an authentication method according to which a verifying entity to authenticate a counterpart and a claimant entity attempting to be authenticated, share a plurality of secret keys and authentication is processed as the claimant entity responds to a challenge by the verifying entity. The authentication method may include the steps of: receiving a challenge key and a first calculated value from the verifying entity; predicting a secret value that corresponds to the first calculated value based on the first calculated value and a first shared secret key shared with the verifying entity; generating a first response value based on a second shared secret key shared with the verifying entity and the challenge key, if the predicted secret value is a first value; converting the challenge key using a permutation function shared with the verifying entity and generates a second response value based on the converted key and the second shared secret key, if the predicted secret value is a second value; and sending one of the first and second response values to the verifying entity.

In accordance with yet another example embodiment of the present invention, there is provided an authentication method a verifying entity to authenticate a counterpart and a claimant entity attempting to be authenticated, share a plurality of secret keys and the verifying entity verifies authenticity of the claimant entity. The authentication method may include the steps of: choosing a challenge key and a secret value; generating a first calculated value based on a first shared secret key shared with the claimant entity, the chosen challenge key, and the secret value; sending the challenge key and the first calculated value to the claimant entity; receiving a response value to the challenge key and the first calculated value from the claimant entity; and verifying the response value based on a second shared secret key shared with the claimant entity, the challenge key and the secret value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a process of executing q rounds of authentication steps between a radio frequency identification (RFID) tag and a RFID reader according to an exemplary embodiment of the present invention;

FIG. 2 illustrates in detail one round of authentication step executed between a RFID tag and a RFID reader according to an exemplary embodiment of the present invention;

FIG. 3 is a flowchart illustrating in detail an authentication process executed at the RFID tag of FIG. 2 according to an exemplary embodiment of the present invention; and

FIG. 4 is a flowchart illustrating in detail an authentication process executed at the RFID reader of FIG. 2 according to an exemplary embodiment of the present invention.

### DETAILED DESCRIPTION OF THE EMBODIMENTS

Reference will now be made in detail to the example embodiments of the present invention, examples of which are illustrated in the accompanying drawings, wherein like reference numerals refer to like elements throughout. The embodiments are described below in order to explain the aspects of the present invention by referring to the figures.

HB authentication protocol proposed by Hopper and Blum brought new approach to designing lightweight cryptographic protocols. HB authentication protocol is based on a new foundation called Learning Parity with Noise (LPN) problem. The core operation in the LPN problem is binary inner-product which requires just a linear number of XOR and AND operations.

LPN problem has been extensively studied and known to be nondeterministic polynomial-complete (NP-complete).

It is known to take 2^{O(n/log n)} even for the fastest algorithm to solve the LPN problem.

Unfortunately, HB protocol is designed for human-to-computer authentication, and cannot be used for device-to-device authentication. An improved protocol called HB+ proposed by Juels and Weis made it possible to use this kind of protocol for device-to-device authentication.

However, both HB and HB+ suffer from a problem called incompleteness. That is, even though genuine claimant and verifier follow protocols correctly, there is still a chance that authentication may fail.

In addition, both HB and HB+ require pseudorandom number generator from a claimant side, that is, from a RFID tag. The RFID tag needs a complicated hardware to generate a pseudorandom number, which increases the price of the RFID tag. Accordingly, an improved protocol is required, by which a low-cost device such as a RFID tag can maintain security without requiring a pseudorandom number generator.

The authentication system and method according to an exemplary embodiment of the present invention use a cryptography based on HB protocol, is perfectly complete and requires no pseudorandom number generator on a RFID tag.

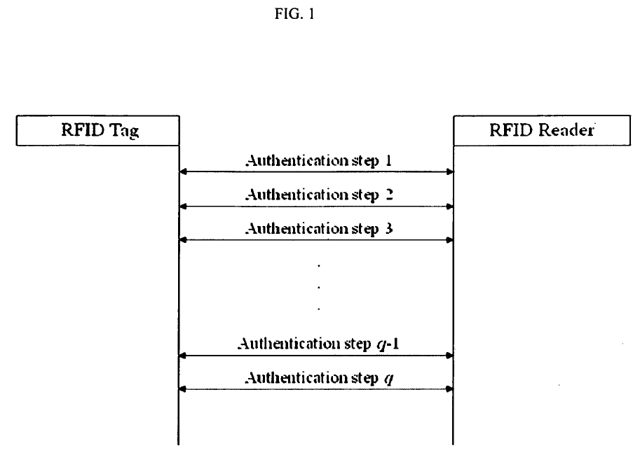

FIG. 1 illustrates q rounds of authentication steps executed between a RFID reader as a verifier and a RFID tag as a claimant.

Efforts have constantly been made to make it easier to identify persons or products especially in the field of commerce. The identity cards or passwords can be the typical examples of the ways to verify the identity of a person, and these traditional methods have appropriately been adapted for use on electronic devices.

However, passwords are easily exposed or stolen. For example, a malicious attacker may steal a credit card password and withdraw deposit from a credit card owner's account.

The magnetic card or radio frequency identification (RFID) is the technology introduced to prevent one's identity or password from being exposed to such a potential identity thief. The RFID enables recognition of information in from several centimeters to several meters of distance depending on the design.

The speed of recognition is approximately 0.01˜0.1 seconds, which is faster and less subjective to an external influence than the other types of media such as magnetic.

The RFID technology chip also can store relatively a large amount of information.

The RFID technology is achieved by data transmission and reception between a RFID reader and a RFID tag. The RFID tag may include an integrated circuit (IC) to store information, and an antenna. The capacity of the RFID tag to store information depends on the size of memory embedded in the IC chip.

The RFID reader may provide energy to operate the RFID tag. The RFID reader may send a command, requesting the RFID tag to perform a specific operation. Accordingly, in response to the command from the RFID reader, the RFID tag may send data to the RFID reader.

The RFID reader and RFID tag may communicate in an inductively coupled manner, or by using electromagnetic waves. The inductively coupled scheme is generally used for short distance communication which is generally within 1 meter, while the electromagnetic wave-based scheme is generally used for middle, or long distance communication exceeding 1 meter.

The energy to operate the RFID tag may be provided by the RFID reader. Alternatively, the RFID tag may be connected to an energy source such as a battery.

According to an exemplary embodiment of the present invention, a verifier, including RFID reader, may request a claimant, including RFID tag, a response. If the claimant sends a response message to the verifier in response, the verifier determines whether or not the response message meets a predetermined rule. If the received response message meets the predetermined rule, the verifier determines the claimant to be a genuine entity and thus gives an access to the information stored in the verifier.

However, if the response message from the claimant does not meet the predetermined rule, the verifier determines authentication to have failed, and refuses the access of the claimant to the verifier.

According to an exemplary embodiment of the present invention, if the authentication is successful, the verifier may additionally read data stored in the claimant, and update the data previously stored in the verifier based on the read data. In this case, the verifier may send a data request command to the claimant, and the claimant may send the requested data to the verifier in response.

According to an exemplary embodiment of the present invention, the verifier may include, or be connected to a database to store information about the registered claimants.

According to an exemplary embodiment of the present invention, the verifier may control a mobile device. Accordingly, if authentication is successful, the verifier may allow the claimant to use the mobile device.

The operation of the verifier requesting a response from the claimant, and determining authentication to be a success or failure based on the received response message, may form one authentication step.

The authentication steps may be executed independently, and authentication is considered to be successful if all q rounds of authentication steps are successful. The q steps may be executed in parallel or sequentially.

The verifier and the claimant may generate session bits in each of the authentication steps, and thus generate q-bit session keys throughout the q steps.

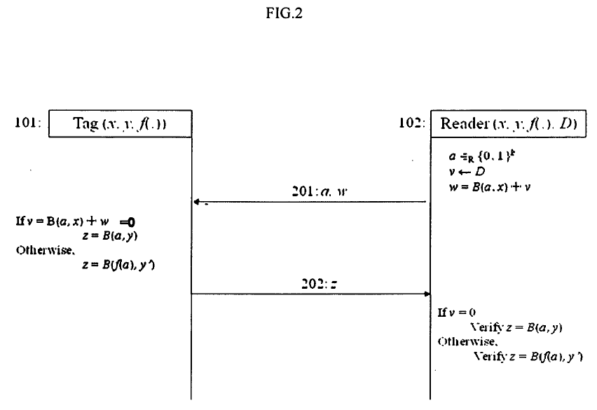

FIG. 2 illustrates in detail each of authentication steps of FIG. 1 according to an exemplary embodiment of the present invention.

The tag 101 and the reader 102 share two secret keys, namely, x and y. The tag 101 and the reader 102 also share a permutation function ƒ( ). The permutation function ƒ( ) may be a system parameter.

The reader 102 may store therein a probability distribution D. The tag 101 does not need to store a probability distribution.

The reader 102 generates a k-bit challenge key a. Each bit of the challenge key a may have one of the values {0, 1}. The reader 102 may generate a challenge key a randomly. Herein, k may be an integer equal to, or greater than 2. For example, k may be 16, 32, 48, 64, or 128.

The reader 102 may choose a 1-bit first secret value v. The reader 102 may choose the first secret value v according to a probability distribution D. The probability distribution D may be treated as a secret. The probability distribution D may be a uniform function or other.

The reader 102 may compute a binary inner-product B (a, x) of the challenge key a and the first shared secret key x. The reader 102 generates a first calculated value w, which may be expressed by:

w=B(a,x) [symbol] v [Mathematical formula 1]

where, denotes [symbol] a logical XOR operation.

The binary inner-product of bit streams of k bit may be computed as explained below.

Given two k-bit numbers a=(a₀a₁ . . . aₖ₋₁)₂ and x=(x₀x₁ . . . xₖ₋₁)₂, the binary inner product of a and x, denoted as B(a, x), can be computed as follows:

B(a,x)=(a₀ [symbol] x₀) [symbol] (a₁ [symbol] x₁) [symbol] . . . [symbol] (aₖ₋₁ [symbol] xₖ₋₁) [Mathematical formula 2]

where [symbol] denotes a logical AND operation.

The reader 102 sends the challenge key a and the first calculated value w to the tag 101.

If the probability distribution D is uniform, the LPN problem instance formed by a collection of (a, w) is intractable. If D is unknown or uniform, the attack on the LPN problem is not effective, and thus the authentication protocol according to an exemplary embodiment of the present invention is secure against the active attack.

The tag 101 is capable of predicting the first secret value v using the received challenge key a and the first calculated value w. The tag 101 may use the first shared secret key x, which is given beforehand, for the prediction of the first secret value v. The predicted first secret value v can be expressed by:

v=B(a,x) [symbol] w [Mathematical formula 3]

The tag 101 may choose one of the first and second encryption equations, depending on whether the predicted first secret key v is the first value or the second value. The tag 101 may generate a response value z based on the selected equation. For example, it is assumed that the first encryption equation is selected if v=0. The first encryption equation may be expressed by:

z=B(a,y) [Mathematical formula 4]

where y is the second shared secret key given to the tag 101 and the reader 102 beforehand.

It is assumed that the second encryption equation is selected if v≠0. The second encryption equation may be expressed by:

z=B(f(a),y′) [Mathematical formula 5]

where y′ is a bit-wise inverse of the second shared secret key y.

ƒ(a) is a bit stream obtained by permuting position of each bit of the challenge key a. For example, if a=(a₀a₁a₂ . . . a₍ₖ₋₁₎)₂, it is possible that ƒ(a)=(a₁a₂a₃ . . . a₍ₖ₋₁₎a₀)₂. Alternatively, it is possible that ƒ(a)=(a₁a₀a₃a₂ . . . a₍ₖ₋₁₎a₍ₖ₋₂₎)₂. ƒ(a) generally has different results of k!, if the challenge key a has k-bit. The attacker on the authentication system needs to have information about the permutation function ƒ( ) used by the tag 101 and the reader 102, in addition to the challenge key a, the first calculated value w, and the response value z between the reader 102 and the tag 101. Since the tag 101 is capable of providing variations corresponding to k! without generating a pseudorandom number by permuting the challenge key a, the tag 101 has hardware of reduced complexity and yet provides increased authentication efficiency according to the exemplary embodiments of the present invention. For example, if k=32, variations of 32!=2.63×10³⁵ are possible, and thus the possibility of having hacking decreases significantly.

The tag 101 may generate a response value z based on the predicted first secret key v, using the first encryption equation or the second encryption equation. The tag 101 sends the response value z to the reader 102.

The reader 102 chooses one of the first and second encryption equations based on the first secret key v, and verifies the response value z using the selected equation.

If v=0, the reader 102 verifies that z=B(a, y); Otherwise, the reader 102 checks if z=B(ƒ(a), y′).

The reader 102 determines that the authentication is successful if v=0, and z=B(a, y). Additionally, the reader 102 may determine that the authentication is successful if v≠0 and z=B(ƒ(a), y′). Otherwise, the reader 102 determines that the authentication is unsuccessful.

Since the tag 101 can compute the response value z using one of the two different formulas, it is unnecessary to add a separate noise component or random number. This authentication sequence thus removes incompleteness problem.

The authentication protocol according to the exemplary embodiments of the present invention may be shortly named as HB-c. HB-c is secure against active attack. HB-c protocol may improve the security level by using a permutation function.

According to HB-c protocol, the satisfactory level of security is possible even when the tag 101 does not have a pseudorandom number generator. Therefore, HB-c protocol is suitably applicable on the low-cost devices such as RFID tags or sensor nodes.

HB-c protocol also does not suffer from incompleteness problem.

HB-c also allows flexibility in choosing a security parameter (the noise distribution D). This potentially improves security strength of HB-c even more

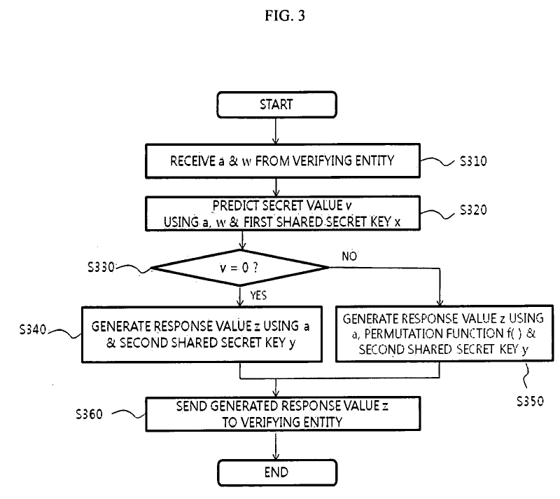

FIG. 3 is a flowchart illustrating in detail the authentication process executed at the tag 101 of FIG. 2 according to an exemplary embodiment of the present invention.

The tag 101 receives a challenge key a and the first calculated value w from a verifier, that is, the reader 102 at S310.

The tag 101 predicts a secret value v, using the challenge key a, first calculated value w and first shared secret key x at S320. The operation at S320 may be performed using mathematical formula 3 explained above.

The tag 101 checks if the predicted secret value is 0, and if so, generates a response value z using the challenge key a and the second shared secret key y at S340. The operation at S340 may be performed using mathematical formula 4 explained above. The tag 101 generates response value z by computing a binary inner-product of the challenge key a and the second shared secret key y. Since the binary inner-product operation consists of logical AND and logical XOR operations, this can be implemented on a simple hardware.

If the predicted secret value is not 0, the tag 101 generates a response value z using the challenge key a, the permutation function ƒ( ), and the second shared secret key y at S350. The operation at S350 may be performed using mathematical formula 5 explained above. The tag 101 may compute a bit-wise inverse (y′) of the second shared secret key y, and also a binary inner-product of ƒ(a) and y′ to generate a response value z. Since the bit-wise inverse computation is also implementable on a simple hardware, the tag 101 does not require a complicated hardware and thus is suitable for the low-cost devices such as RFID tags.

The tag 101 sends a response value z, either generated at S340 or S350, to the verifier, that is, to the reader 102 at S360.

The tag 101 may execute q rounds of S310 to S360 independently. Since the reader 102 considers the authentication to be successful only when all q rounds are successful, the higher q ensures the higher security.

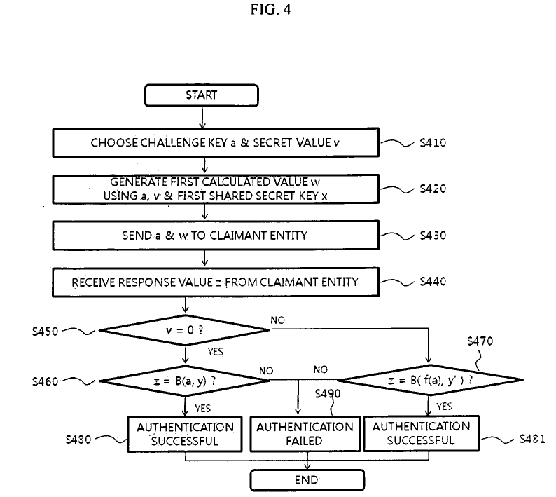

FIG. 4 is a flowchart illustrating in detail the process of authentication executed at the reader 102 of FIG. 2 according to an exemplary embodiment of the present invention.

The reader 102 chooses a challenge key a and a secret value v at S410.

The reader 102 may generate a secret value v based on a probability distribution D. The probability distribution D may be uniform function or other. If the probability distribution D is uniform, the LPN problem instance formed by a collection of (a, w) is intractable, and so the attack on the LPN problem is ineffective.

The reader 102 has flexibility in choosing a probability distribution D, and this potentially improves security strength of the present invention even more.

The reader 102 generates a first calculated value w using the challenge key a, the secret value v, and the first shared secret key x at S420. The operation at S420 may be performed using mathematical formula 1 explained above.

The reader 102 sends the challenge key a, and the first calculated value w to the tag 101 at S430.

The reader 102 receives a response value z from the tag 101 at S440. The response value z is the value generated as the tag 101 executes S310 to S360.

The reader 102 checks the secret value v, and based on the secret value v, chooses an encryption equation to be used in verifying the response value z. The reader 102 verifies if the secret value v is 0 at S450.

If the secret value v is 0, the reader 102 verifies if the response value z meets mathematical formula 4 at S460. If the response value z meets mathematical formula 4, the reader 102 verifies that the authentication is successful at S480. If the response value z does not meet mathematical formula 4, the reader 102 determines the authentication to have failed at S490.

If the secret value v is not 0, the reader 102 determines if the response value z meets mathematical formula 5 at S470. If the response value z meets mathematical formula 5, the reader 102 verifies that the authentication is successful at S481. If the response value z does not meet mathematical formula 5, the reader 102 determines the authentication to have failed at S490.

The reader 102 may execute q rounds of S410 to S490. These q rounds may be independent from, or dependent on one another. The q rounds can be executed sequentially or in parallel.

The reader 102 considers the authentication to be successful only when the authentication of all q rounds is considered to be successful. Each of q rounds may independently use the secret value v which is generated by a probability distribution D. If the probability distribution D is uniform, the secret value v generated in the q rounds has randomness, and thus is hardly tractable by an attacker. Therefore, higher q ensures higher security of a system according to an exemplary embodiment of the present invention.

The method according to the exemplary embodiments of the present invention may be realized as a program command which can be executed by a variety of computer means, and recorded on a computer-readable medium. The ‘computer-readable medium’ herein may refer to a program command, data file, data structure, or any combination thereof. The program command recorded on the medium may be designed and constructed specifically for application of the exemplary embodiments of the present invention, or alternatively, the program command may be that which is already known to and used by those skilled in the field of computer software. The computer readable medium may include a magnetic media such as hard disk, floppy disk or magnetic tape, an optical media such as CD-ROM or DVD, a magneto-optical media such as floptical disk, and a hardware device such as ROM, RAM or flash memory, which is constructed specifically to store and execute the program command. The program command may include not only a mechanical language code which is constructed by a compiler, but also an advanced language code which can be executed on a computer using appropriate tool such as an interpreter. The hardware device may be designed to operate as one or more software modules to execute the steps according to the exemplary embodiments of the present invention, or the opposite is also possible.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof.

Accordingly, it is intended, therefore, that the present invention not be limited to the various example embodiments disclosed, but that the present invention includes all embodiments falling within the scope of the appended claims.

What is claimed is:

1. An authentication method, according to which a claimant entity attempting to be authenticated and a verifying entity to authenticate the claimant entity, share a plurality of secret keys and authenticity is verified as the claimant entity responds to a challenge by the verifying entity, the authentication method comprising:
receiving a challenge key and a first calculated value from the verifying entity;
predicting a secret value corresponding to the first calculated value based on the challenge key, the first calculated value and a first shared secret key shared with the verifying entity;
generating a first response value based on a second shared secret key shared with the verifying entity and the challenge key, if the predicted secret value corresponds to a first value;
converting the challenge key using a permutation function shared with the verifying entity and generating a second response value based on the converted key and the second shared secret key, if the predicted secret value corresponds to a second value; and
sending one of the first and second response values to the verifying entity based on the predicted secret value.

2. The authentication method of claim 1, wherein the steps of the receiving, the predicting, the sending, and the generating of the first response value or the generating of the second response value, are repeated a plurality of times, and the authentication of the verifying entity is determined to be successful if authentication of all the repeated steps succeeds.

3. The authentication method of claim 1, wherein the generating of the first response value generates the first response value by performing a binary inner-product operation of the challenge key and the second shared secret key.

4. The authentication method of claim 1, wherein the generating of the second response value comprises:
generating a first operation key by computing a bit-wise inverse of the second shared secret key; and
generating the second response value by computing a binary inner-product of the converted key and the first operation key.

5. The authentication method of claim 1, wherein the secret value corresponding to the first calculated value is generated based on a probability distribution function that only the verifying entity has.

6. An authentication method, according to which a claimant entity attempting to be authenticated and a verifying entity to authenticate the claimant entity, share a plurality of secret keys and authenticity is verified as the claimant entity responds to a challenge by the verifying entity, the authentication method comprising:
choosing a challenge key and a secret key;
generating a first calculated value based on a first shared secret key shared with the claimant entity, and the chosen challenge and secret keys;
sending the challenge key and the first calculated value to the claimant entity;
receiving from the claimant entity a response value to the challenge key and the first calculated value; and
verifying the response value based on the secret value, using a second shared secret key shared with the claimant entity, the challenge key, and a permutation function shared with the claimant entity.

7. The authentication method of claim 6, wherein the verifying comprises:
generating a second calculated value based on the challenge key and the second shared secret key, if the secret value is a first value;
converting the challenge key using a permutation function shared with the claimant entity and generating a third calculated value based on the converted key and the second shared secret key, if the secret value is a second value;
determining the authentication to be successful, if the secret value is the first value and the response value matches the second calculated value; and
determining the authentication to be successful, if the secret value is the second value and the response value matches the third calculated value.

8. The authentication method of claim 7, wherein the generating of the second calculated value generates the second calculated value by computing a binary inner-product of the challenge key and the second shared secret key.

9. The authentication method of claim 7, wherein the generating of the third calculated value comprises:
generating a first operation key by computing a bit-wise inverse of the second shared secret key; and
generating the third calculated value by computing a binary inner-product of the first operation key and the converted key.

10. The authentication method of claim 6, wherein the steps of the choosing, the generating, the sending, the receiving, and the verifying, are repeated a plurality of times, and the authentication of the claimant entity is determined to be successful if authentication of all the repeated steps succeeds.

11. An authenticating system, comprising:
a verifying entity; and
a claimant entity,
wherein the verifying entity and the claimant entity share a first shared secret key, a second shared secret key and a permutation function, and authentication is processed as the claimant entity responds to a challenge by the verifying entity.

12. The authentication system of claim 11, wherein the verifying entity
chooses a challenge key and a secret key,
chooses a first calculated value based on the first shared secret key, the challenge key and the secret value, and
sends the challenge key and the first calculated value to the claimant entity.

13. The authentication system of claim 11, wherein the claimant entity comprises a predicting unit and a responding unit,
the predicting unit receives the challenge key and the first calculated value from the verifying entity, and predicts a secret value which corresponds to the first calculated value based on the challenge key, the first calculated value, and the first shared secret key; and
the responding unit generates a first response value based on the second shared secret key and the challenge key and sends the first response value to the verifying entity if the predicted secret value corresponds to a first value, converts the challenge key using a permutation function shared with the verifying entity, generates a second response value based on the converted key and the second shared secret key, and sends the second response value to the verifying entity if the predicted secret value corresponds to a second value.
